(19) United States
(12) Patent Application Publication
(10) Pub. No.: US 2017/0057319 A1
(43) Pub. Date: Mar. 2, 2017

(54) AIR INLET ASSEMBLY WITH SHUTTER MEMBER

(71) Applicant: GM GLOBAL TECHNOLOGY OPERATIONS LLC, Detroit, MI (US)

(72) Inventors: David T. Renke, Macomb, MI (US); Christopher S. Aude, Macomb Township, MI (US); Sorin Ratiu, Macomb, MI (US)

(73) Assignee: GM GLOBAL TECHNOLOGY OPERATIONS LLC, Detroit, MI (US)

(21) Appl. No.: 14/840,585

(22) Filed: Aug. 31, 2015

(51) Int. Cl. B60H 1/00; B60H 1/28

(52) U.S. Cl. CPC B60H 1/008; B60H 1/28; B60H 1/00849

(57) ABSTRACT

An air inlet assembly selectively directs intake air from an exterior region to an interior region. The assembly includes an inlet panel having a first inlet wall defining an aperture and a shutter member. The shutter member is movable relative to the inlet panel between a plurality of positions, including a closed position and an open position. The shutter member includes a vented section operative to provide airflow communication between the exterior and interior region such that the vented section is visible through the aperture when the shutter member is in the open position. The shutter member includes a non-vented section restricting airflow communication between the exterior and interior region such that the non-vented section is visible through the aperture when the shutter member is in the closed position.

### TECHNICAL FIELD

The disclosure relates generally to an air inlet assembly with a shutter member, and a vehicle having the same.

### BACKGROUND

Many devices require the intake of fresh air for use in an internal circulation system. For example, a vehicle may include vents for the intake of fresh air into a heating, ventilation and air-conditioning unit.

### SUMMARY

An air inlet assembly selectively directs intake air from an exterior region to an interior region. The assembly includes an inlet panel having a first inlet wall defining an aperture and a shutter member. The shutter member is movable relative to the inlet panel between a plurality of positions, including a closed position and an open position. The shutter member includes a vented section operative to provide airflow communication between the exterior and interior region such that the vented section is visible through the aperture when the shutter member is in the open position. The shutter member includes a non-vented section restricting airflow communication between the exterior and interior region such that the non-vented section is visible through the aperture when the shutter member is in the closed position.

The assembly may be employed in any device, including but not limited to, a vehicle. The assembly optimizes air flow while protecting components under the air inlet panel when additional air flow is not required. The shutter member may include an arcuate main panel with first and second ends. The vented section may define a first angle on the arcuate main panel relative to an origin. The non-vented section may define a second angle on the arcuate main panel relative to the origin. The shutter member may include a secondary non-vented section that defines a third angle on the arcuate main panel relative to the origin.

The shutter member may include first and second side shutter panels each abutting the main shutter panel. An actuator may be operatively connected to the shutter member. A link is operatively connected to the actuator and the shutter member. The shutter member may include a first post extending from an exterior surface of the first side shutter panel and configured to fit into the first hole of the link, such that the shutter member is rotatably pivoted at the first post.

A controller may be operatively connected to the actuator. The controller may be programmed to cause the shutter member to move, via the actuator, to the open position when at least one opening condition is satisfied. In one example, the at least one opening condition is satisfied when the vehicle has moved at a predefined threshold speed for a predefined threshold time. A temperature sensor may be operatively connected to the controller and configured to detect an ambient temperature. In another example, the at least one opening condition includes a first opening condition that is satisfied when the vehicle has moved at a predefined threshold speed for a predefined threshold time and a second opening condition that is satisfied when the ambient temperature is above a threshold temperature.

The plurality of positions may include an intermediate position such that a first portion of the vented section and a second portion of the non-vented section are both visible through the aperture. The controller may be programmed to cause the shutter member to move, via the actuator, to the intermediate position when one or more intermediate conditions are satisfied.

The controller may be programmed to cause the shutter member to move, via the actuator, to the closed position when at least one closing condition is satisfied. A blower fan may be positioned in the interior region and have a variable speed setting. A chamber may be operatively connected to the inlet panel. A fluid level sensor may be configured to detect fluid level in the chamber relative to a chamber floor.

The controller may be programmed to position the shutter member in the closed position when the fluid level is above a first predefined threshold fluid level and the variable speed setting of the blower fan is at or above a first threshold speed setting. The controller may be programmed to position the shutter member in the intermediate position when the fluid level is above a second predefined threshold fluid level and the variable speed setting of the blower fan is below a second threshold speed setting.

The assembly may include an odor sensor configured to detect an odor level of a predefined gas in the chamber. The at least one closing condition may be satisfied when the odor level is above a predefined threshold odor level. The predefined gas may be carbon monoxide. The predefined gas may be an oxide of sulfur. When employed in a vehicle, the air inlet assembly provides an optimized air flow condition while preventing damage to other systems due to excess fluid, e.g., water, intrusion

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary perspective view of an air inlet assembly employed in a vehicle, the assembly having a shutter member in an open position;

FIG. 2 is a schematic fragmentary partly perspective, partly sectional cut-away view through section 2-2 of the assembly of FIG. 1, with the shutter member in an intermediate position;

FIG. 3 is a schematic fragmentary sectional view of the assembly of FIG. 1, with the shutter member in a closed position;

FIG. 4 is a schematic perspective view of the shutter member; and

FIG. 5 is a schematic fragmentary partly perspective, partly sectional view of the assembly of FIG. 2, with the shutter member in a closed position.

### DETAILED DESCRIPTION

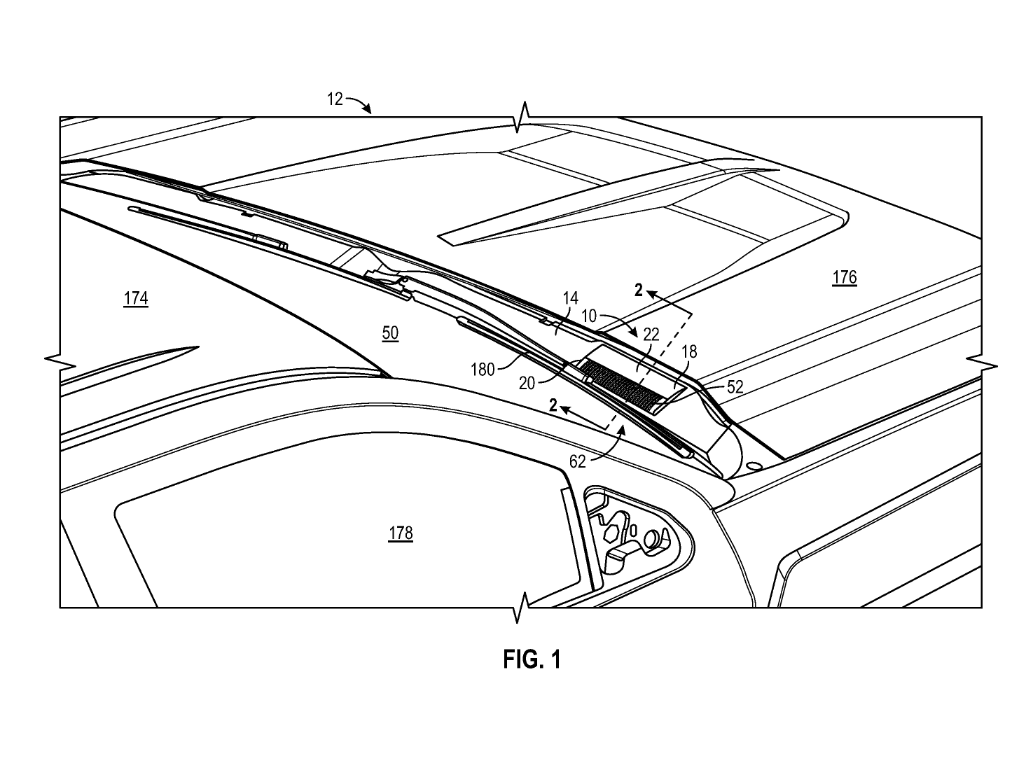

Referring to the Figures, wherein like reference numbers refer to the same or similar components throughout the several views, FIG. 1 is a schematic fragmentary perspective view of an air inlet assembly 10 employed in a vehicle 12. It is to be understood that the assembly 10 may be employed in any device, including but not limited to, the vehicle 12. For example, the assembly 10 may be employed in a farm implement, sports-related equipment, a robotic device or any other type of device. The assembly 10 may take many different forms and include multiple and/or alternate components and facilities. While an example assembly 10 is shown in the Figures, the components illustrated in the Figures are not intended to be limiting. Indeed, additional or alternative components and/or implementations may be used.

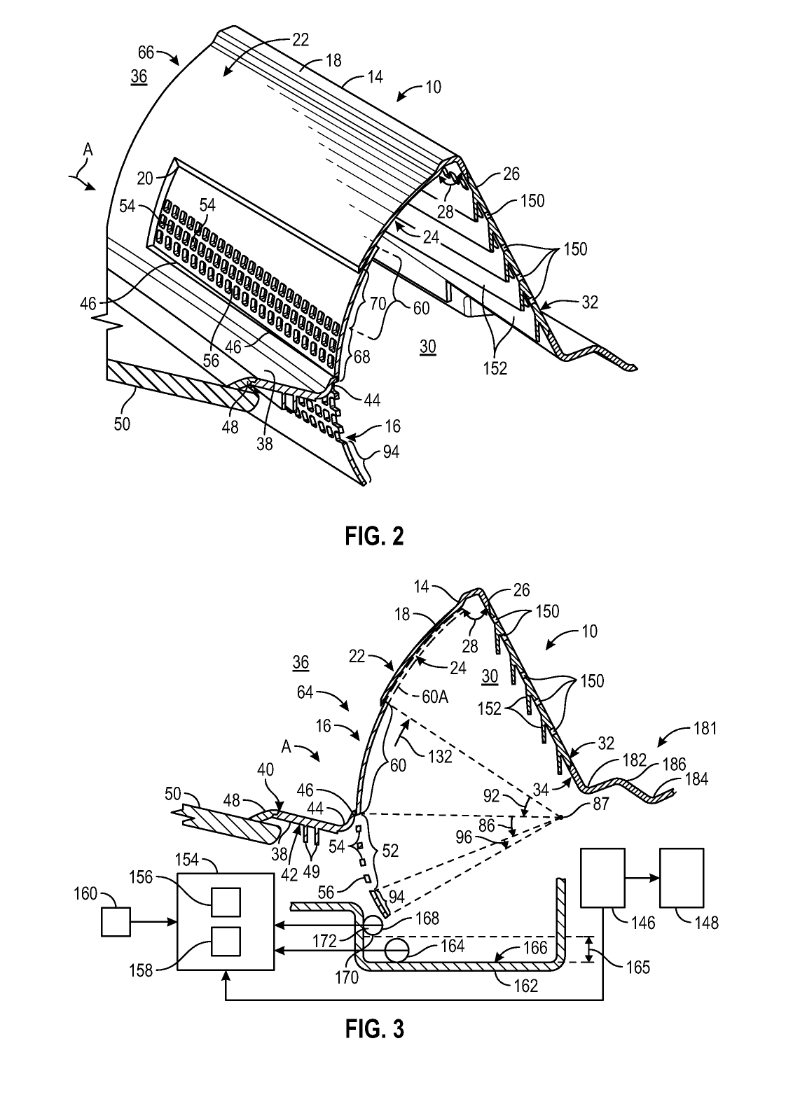

FIG. 2 is a schematic fragmentary, partly perspective, partly sectional cut-away view through section 2-2 of the assembly 10. FIG. 3 is a schematic fragmentary sectional view of the assembly 10. Referring to FIGS. 1-3, the assembly 10 includes an inlet panel 14 and a shutter member 16. Referring to FIGS. 1-3, the inlet panel 14 has a first inlet wall 18 defining an aperture 20. Referring to FIG. 2, the first inlet wall 18 defines a first exterior side 22 and a first interior side 24. Referring to FIG. 3, the inlet panel 14 may include a second inlet wall 26 contiguous with the first inlet wall 18 and oriented at a inlet angle 28 relative to the first inlet wall 18 to define an interior region 30. In a non-limiting example, the inlet angle 28 may be 45 degrees. The second inlet wall 26 defines a second exterior side 32 and a second interior side 34.

Referring to FIGS. 2-3, the assembly 10 selectively directs intake air A from an exterior region 36 to the interior region 30. Referring to FIGS. 2-3, the inlet panel 14 may include a third inlet wall 38 contiguous with the first inlet wall 18. The third inlet wall 38 defines a third exterior side 40 and a third interior side 42. The exterior region 36 faces the respective first, second and third exterior sides 22, 32, 40 of the first, second and third walls 18, 26 and 38. The interior region 30 faces the respective first, second and third interior sides 24, 34, 42 of the first, second and third inlet walls 18, 26 and 38.

Referring to FIGS. 2-3, the third inlet wall 38 may include an inwardly curved portion 44 (with a dip facing the interior region) which abuts the shutter member 16 at an intersection line 46. Referring to FIGS. 2-3, the third inlet wall 38 may include an outwardly curved portion 48 (with a dip facing the exterior region) for operatively connecting the third inlet to a component, such as windshield 50 of the vehicle 12. Referring to FIGS. 2-3, the third inlet wall 38 may include ribs 49 for enhanced rigidity.

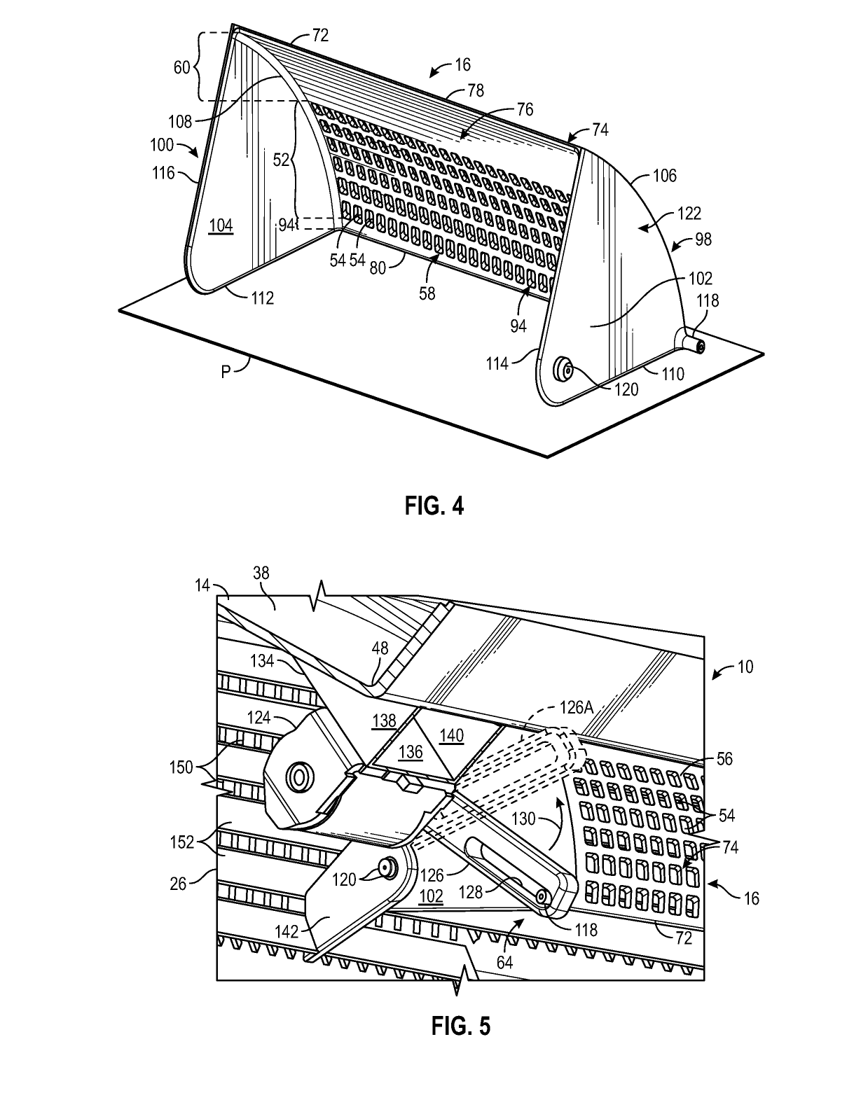

FIG. 4 is a schematic perspective view of the shutter member 16. The shutter member 16 includes a vented section 52 having a plurality of openings 54, each separated by respective gaps 56. In the embodiment shown, the openings 54 are substantially rectangular and uniform in shape and arranged in a plurality of rows 58. However, the openings 54 and respective gaps 56 may be of any size, shape or number suitable for the particular application and may be uniform or non-uniform. The vented section 52 is operative to provide airflow communication between the exterior region 36 and the interior region 30.

The shutter member 16 includes a non-vented section 60 (i.e. made of a non-porous material without holes) restricting airflow communication between the exterior region 36 and the interior region 30. The shutter member 16 may be made of any suitable material. In one example, the shutter member 16 is made of polypropylene.

The shutter member 16 is movable relative to the inlet panel 14 between a plurality of positions. Referring to FIG. 1, the shutter member 16 is shown in an open position 62, in which the vented section 52 is visible through the aperture 20. Referring to FIG. 3, the shutter member 16 is shown in a closed position 64, in which the non-vented section 60 is visible through the aperture 20. In one embodiment, only the vented section 52 is visible through the aperture 20 when the shutter member 16 is in the open position 62 and only the non-vented section 60 is visible through the aperture 20 when the shutter member 16 is in the closed position 64. Referring to FIG. 2, the shutter member 16 is shown in an intermediate position 66, in which a first portion 68 of the vented section 52 and a second portion 70 of the non-vented section 60 are both visible through the aperture 20. Referring to FIG. 3, the phantom non-vented profile 60A indicates the location of the non-vented section 60 when the shutter member 16 is in the open position 62.

Referring to FIG. 4, the shutter member 16 may include an arcuate main panel 72 having a main exterior side 74 (facing the exterior region), a main interior side 76 (facing the interior region) and first and second ends 78, 80. Referring to FIG. 3, the vented section 52 and non-vented section 60 may be formed or positioned on the arcuate main panel 72. The vented section 52 subtends a first angle 86 on the arcuate main panel 72 relative to an origin 87. Similarly, the non-vented section 60 subtends a second angle 92 relative to the origin 87. The shutter member 16 may include a secondary non-vented section 94 subtending a third angle 96 relative to the origin 87. In one example, the first, second and third angles 86, 92 and 96 are 27.5, 27.5 and 10 degrees, respectively. The first, second and third angles 86, 92 and 96 may be varied based on the application at hand. The first angle 86 may be equal to the second angle 92.

Referring to FIG. 4, the shutter member 16 includes first and second side shutter panels 98, 100 each having respective bodies 102, 104 abutting the arcuate main panel 72 at their respective first edges 106, 108. The first and second side shutter panels 98, 100 include respective second edges 110, 112 that are contiguous with the respective first edges 106, 108. The first and second side shutter panels 98, 100 include respective third edges 114, 116 that are contiguous with the respective first edges 106, 108. The first and second side shutter panels 98, 100 may form a substantially triangular shape. The respective second edges 110, 112 of the first and second side shutter panels may each be level with or co-planar with (i.e., see common plane P shown in FIG. 4) the second end 80 of the arcuate main panel 72. The shutter member 16 may include first and second posts 118, 120 extending from an exterior side 122 of the first side shutter panel 98.

FIG. 5 is a schematic fragmentary partly perspective, partly sectional view of the assembly of FIG. 2, with the shutter member 16 in the closed position 64. Referring to FIG. 5, an actuator 124 may be operatively connected to the shutter member 16 and configured to move the shutter member 16. In one example, the actuator 124 is an electric motor. The actuator 124 may be a linear actuator, a rotary actuator, a stepper motor, a shape memory alloy or any other type of actuator known to those skilled in the art. The shutter member 16 may be mechanized in any way known to those skilled in the art.

In the embodiment shown in FIG. 5, the actuator 124 may be configured to drive or move the shutter member 16 via a link 126. The actuator 124 may be rigidly connected to the link 126. The shutter member 16 may be rotatably pivoted relative to the link 126 at the first post 118. The first post 118 may extend through a first hole 128 of the link 126. Referring to FIG. 5, motion of the actuator 124 causes the link 126 to move in the direction 130 (shown in FIG. 5), in turn causing motion of the shutter member 16, indicated by arrow 132 (shown in FIGS. 3 and 5). Referring to FIG. 5, the link 126 (solid line) is shown in the open position 62. The phantom link profile 126A indicates the location of the link 126 when the shutter member 16 is in the open position 62. The actuator 124 may include a shaft (not shown) configured to fit into a second hole (not shown) of the link 126.

Referring to FIG. 5, the actuator 124 may be attached to the third inlet wall 38 via a bracket 134. However, the actuator 124 may be attached to the inlet panel 14 in any suitable way and to any portion of the inlet panel 14. The bracket 134 may include first, second and third bracket sides 136, 138, 140 such that the first bracket side 136 is contiguous with and perpendicular to each of the second and third bracket sides 138, 40. Referring to FIG. 5, the shutter member 16 may be attached to the inlet panel 14 via a connector 142 that is rigidly attached to the inlet panel 14. The connector 142 may be integrally formed with the second inlet wall 26 of the inlet panel 14. The second post 120 of the first side shutter panel 98 may be configured to fit into a slot 144 of the connector 142.

Referring to FIG. 3, a blower fan 146 may be positioned in the interior region 30. The blower fan 146 may be part of a heating, ventilation and air-conditioning (HVAC) unit (not shown). The blower fan 146 may have a variable speed setting and may be configured to direct the airflow from the interior region 30 to an enclosure 148, such as the passenger vehicle compartment. Referring to FIGS. 2-3, the second inlet wall 26 of the inlet panel 14 may include multiple secondary vents 150 allowing further airflow from the exterior region 36 to the interior region 30. The second inlet wall 26 may include respective flow restrictors 152 extending from the second interior side 34, adjacent to the secondary vents 150. The flow restrictors 152 may be configured to direct airflow towards the blower fan 146.

Referring to FIG. 3, the assembly 10 may include a controller 154 operatively connected to the actuator 124 and the shutter member 16. The controller 154 includes a processor 156 and tangible, non-transitory memory 158 on which are recorded instructions for controlling the position of the shutter member 16. The controller 154 may be programmed to cause the shutter member 16 to move, via the actuator 124, to the open position 62 (FIG. 1) when at least one opening condition is satisfied. The controller 154 may be programmed to cause the shutter member 16 to move, via the actuator 124, to the closed position 64 (FIG. 3) when at least one closing condition is satisfied. The controller 154 may be programmed to cause the shutter member 16 to move, via the actuator 124, to the intermediate position 66 (FIG. 2) when at least one intermediate condition is satisfied.

If the assembly 10 is employed in the vehicle 12, the shutter member 16 may be placed in the closed position 64 when the vehicle 12 is keyed off Once the vehicle 12 is keyed on, the shutter member 16 may be placed in the open position 62 or intermediate position 66 when at least one opening condition or intermediate condition, respectively, is met. In one example, the opening condition is satisfied when the vehicle 12 has moved at a predefined first threshold speed for a predefined first threshold time. This enables any debris accumulated above the windshield 50 to be aerodynamically removed through the motion of the vehicle 12, prior to the opening of the shutter member 16.

Referring to FIG. 3, the assembly 10 may include a temperature sensor 160 operatively connected to the controller 154 and configured to detect the ambient temperature. The opening conditions may include a first opening condition which is satisfied when the ambient temperature is above a threshold ambient temperature and a second opening condition which is satisfied when the vehicle 12 has moved at a predefined first threshold speed for a predefined first threshold time. In one example, the predefined first threshold speed is 30 miles per hour and the predefined first threshold time is 6 minutes. The controller 154 may be programmed to move the shutter member 16 to the open position 62 when both the first and second opening conditions are satisfied. An example threshold ambient temperature is 30 F. This enables any snow or ice accumulated above the windshield to be melted or aerodynamically removed.

The intermediate condition may include a first intermediate condition which is satisfied when the ambient temperature is above the threshold ambient temperature and a second intermediate condition which is satisfied when the vehicle 12 has moved at a predefined second threshold speed for a predefined second threshold time. The controller 154 may be programmed to move the shutter member 16 to the intermediate position 66 when both the first and second intermediate conditions are satisfied. In one example, the predefined second threshold speed is 20 miles per hour and the predefined first threshold time is 4 minutes.

Referring to FIG. 3, the chamber 162 may be operatively connected to the inlet panel 14. The chamber 162 may be a plenum of the vehicle 12 and positioned adjacent to the edge of the windshield 50. Referring to FIG. 3, the assembly 10 may include a fluid level sensor 164 is configured to detect fluid level 165 in the chamber 162, measured relative to a chamber floor 166. The chamber floor 166 may collect fluid, such as rain water, that enters the interior region 30. In one example, the at least one closing condition is satisfied when the fluid level 165 is above a predefined threshold fluid level. In another example, the closing conditions may include first and second closing conditions that both must be satisfied, e.g., a first closing condition that is satisfied when the fluid level 165 is above a first predefined threshold fluid level and a second closing condition that is satisfied when the variable speed setting of the blower fan 146 is below a first threshold speed setting. This prevents fluids entering through the shutter member 16 from interfering with the blower fan 146 when it is operating at or above a threshold speed setting.

The controller 154 may be programmed to position the shutter member 16 in the intermediate position 66 (shown in FIG. 2) when the fluid level 165 is above a second predefined threshold fluid level and the variable speed setting of the blower fan 146 is below a second threshold speed setting. The respective sizes of the first portion 68 relative to the second portion 70 in the intermediate position 66 may be based on the amount of airflow required and the number of available sources of air.

Referring to FIG. 3, the assembly 10 may include an odor sensor 168 operatively connected to the controller 154 and configured to detect an odor level of a predefined gas. The odor sensor 168 may be mounted on a wall of the chamber 162. In one example, the at least one closing condition is satisfied when the odor level detected by the odor sensor 168 is above a predefined threshold odor level. In other words, the controller 154 may be programmed to cause the shutter member 16 to move, via the actuator 124, to the closed position 64 if an undesired odor or gas is detected. The predefined gas may be selected based on the particular application. The predefined gas may be carbon monoxide. The predefined gas may be an oxide of sulfur. The odor sensor 168 may include a sensor material 170 and electronic interface 172. The sensor material 170 may be sensitive to the predefined gas and experiences a change of electrical or physical properties when in contact with the molecules of the predefined gas. The change in electrical or physical properties, such as electrical resistance or voltage, is proportional to the amount of odor detected. The response of the sensor material 170 may be recorded by the electronic interface 172 which transforms the signal into a digital value for delivery to the controller 154.

It is understood that the odor sensor 168 may employ any type of sensor material 170 known to those skilled in the art. The sensor material 170 may include metal-oxide-semiconductor (MOSFET) devices, conducting polymers or polymer composites formulated of non-conducting polymers with the addition of conducting material such as carbon black. The sensor material 170 may include a quartz crystal resonator as a way of measuring mass per unit area by measuring the change in frequency of the quartz crystal resonator. The sensor material 170 may include surface acoustic waves (SAW), which are a class of microelectro-mechanical systems (MEMS) relying on the modulation of surface acoustic waves to sense a physical phenomenon.

Referring back to FIG. 1, the vehicle 12 may include a roof 174, hood 176, front window 178, windshield wiper blade 180, in addition to the windshield 50. The first inlet wall 18 may extend laterally along the width of the vehicle 12. When employed in a vehicle 12, the assembly 10 provides an optimized air flow condition while protecting components under the inlet panel 14 when additional air flow is not required. Referring to FIG. 1, the second inlet wall 26 may include a plurality of curves at a distal end 181, including a first valley 182, a second valley 184, and a peak 186 between the first and second valleys 182, 184. The curves are configured to protect components under the inlet panel 14. When employed in a vehicle 12, the controller 154 may be an integral portion of, or a separate module operatively connected to, other control modules of the vehicle 12. The vehicle 12 may be any passenger or commercial automobile such as a hybrid electric vehicle, including a plug-in hybrid electric vehicle, an extended range electric vehicle, fuel cell or other vehicles.

As noted above, the controller 154 of FIG. 1 may include a computing device that employs an operating system or processor 156 and memory 158 for storing and executing computer-executable instructions. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor 156 (e.g., a microprocessor) receives instructions from the memory and executes these instructions, thereby performing one or more processes, including one or more of the processes described herein. Such instructions and other data may be stored and transmitted using a variety of computer-readable media.

The memory 158 may include a computer-readable medium. A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. An air inlet assembly for selectively directing intake air from an exterior region to an interior region, the assembly comprising:
an inlet panel having a first inlet wall defining an aperture;
a shutter member configured to be movable relative to the inlet panel between a plurality of positions, including a closed position and an open position;
wherein the shutter member includes a vented section operative to provide airflow communication between the exterior region and the interior region, and a non-vented section restricting airflow communication between the exterior and interior region; and
wherein the vented section is visible through the aperture when the shutter member is in the open position and the non-vented section is visible through the aperture when the shutter member is in the closed position.

2. The assembly of claim 1, wherein:
the shutter member includes an arcuate main panel with first and second ends;
the vented section subtends a first angle on the arcuate main panel relative to an origin;
the non-vented section subtends a second angle on the arcuate main panel relative to the origin; and
the shutter member includes a secondary non-vented section subtending a third angle on the arcuate main panel relative to the origin.

3. The assembly of claim 2, further comprising:
the shutter member includes first and second side shutter panels each abutting the main shutter panel;
an actuator and a link each operatively connected to the shutter member, the actuator being rigidly operatively connected to the link;
wherein the link includes a first hole; and
wherein the shutter member includes a first post extending from an exterior surface of the first side shutter panel and configured to fit into the first hole of the link such that the shutter member is rotatably pivoted at the first post.

4. The assembly of claim 1, further comprising:
an actuator operatively connected to and configured to move the shutter member;
a controller operatively connected to the actuator;
wherein the controller is programmed to cause the shutter member to move, via the actuator, to the open position when at least one opening condition is satisfied; and
wherein the controller is programmed to cause the shutter member to move, via the actuator, to the closed position when at least one closing condition is satisfied.

5. The assembly of claim 4, further comprising:
a temperature sensor operatively connected to the controller and configured to detect ambient temperature;
wherein the at least one opening condition includes a first and a second opening condition such that the first opening condition is satisfied when the vehicle has moved at a predefined threshold speed for a predefined threshold time and the second opening condition is satisfied when the ambient temperature is above a threshold temperature; and
wherein the controller is programmed to position the shutter member in the open position when both the first and the second opening conditions are satisfied.

6. The assembly of claim 4, further comprising:
a blower fan positioned in the interior region and having a variable speed setting;
a chamber operatively connected to the inlet panel;
a fluid level sensor configured to detect fluid level in the chamber relative to the chamber floor;
wherein the at least one closing condition includes a first and a second closing condition such that the first closing condition is satisfied when the fluid level is above a first predefined threshold fluid level and the second closing condition is satisfied when the variable speed setting of the blower fan is below a first threshold speed setting; and
wherein the controller is programmed to position the shutter member in the closed position when both the first and the second closing conditions are satisfied.

7. The assembly of claim 4, wherein:
the plurality of positions includes an intermediate position such that a first portion of the vented section and a second portion of the non-vented section are both visible through the aperture when the shutter member is in the intermediate position;
wherein the controller is programmed to cause the shutter member to move, via the actuator, to the intermediate position when at least one intermediate condition is satisfied.

8. The assembly of claim 7, further comprising:
a blower fan positioned in the interior region and having a variable speed setting;
a chamber operatively connected to the inlet panel;
a fluid level sensor configured to detect fluid level in the chamber relative to the chamber floor;
wherein the at least one intermediate condition includes a first and a second intermediate condition such that the first intermediate condition is satisfied when the fluid level is above a second predefined threshold fluid level and the second intermediate condition is satisfied when the variable speed setting of the blower fan is below a second threshold speed setting; and
wherein the controller is programmed to position the shutter member in the intermediate position when both the first and the second intermediate conditions are satisfied.

9. The assembly of claim 4, further comprising:
an odor sensor operatively connected to the chamber and configured to detect an odor level of a predefined gas; and
wherein the at least one closing condition is satisfied when the odor level is above a predefined threshold odor level.

10. The assembly of claim 9, wherein the predefined gas is carbon monoxide.

11. The assembly of claim 9, wherein the predefined gas is an oxide of sulfur.

12. A vehicle having an interior region inside the vehicle and an exterior region outside the vehicle, the vehicle comprising:
an air inlet assembly for selectively directing intake air from the exterior region to the interior region and including:
an inlet panel having a first inlet wall defining an aperture; and
a shutter member operatively connected to the inlet panel and configured to selectively at least partially cover the aperture;
wherein the shutter member is movable relative to the inlet panel between a plurality of positions, including a closed position and an open position;
wherein the shutter member includes a vented section operative to provide airflow communication between the exterior and interior region and a non-vented section restricting airflow communication between the exterior and interior region; and
wherein the vented section is visible through the aperture when the shutter member is in the open position and the non-vented section is visible through the aperture when the shutter member is in the closed position.

13. The vehicle of claim 12, wherein:
the shutter member includes an arcuate main panel with first and second ends;
wherein the vented section subtends a first angle on the arcuate main panel relative to an origin;
wherein the non-vented section subtends a second angle on the arcuate main panel relative to the origin; and
wherein the shutter member includes a secondary non-vented section subtending a third angle on the arcuate main panel relative to the origin.

14. The vehicle of claim 13, wherein:
the shutter member includes first and second side shutter panels having respective first edges each abutting the arcuate main panel;
the first and second side shutter panels include respective second edges contiguous with the respective first edges;
the first and second side shutter panels include respective third edges contiguous with the respective first edges;
the first and second side shutter panels each form a substantially triangular shape; and
the respective second edges of the first and second side shutter panels are each co-planar with the second end of the arcuate main panel.

15. The vehicle of claim 12, further comprising:
an actuator operatively connected to the shutter member;
a controller operatively connected to the actuator;
wherein the controller is programmed to cause the shutter member to move, via the actuator, to the open position when at least one opening condition is satisfied; and
wherein the controller is programmed to cause the shutter member to move, via the actuator, to the closed position when at least one closing condition is satisfied.

16. The vehicle of claim 15, wherein:
the plurality of positions includes an intermediate position such that a first portion of the vented section and a second portion of the non-vented section are both visible through the aperture when the shutter member is in the intermediate position;
wherein the controller is programmed to cause the shutter member to move, via the actuator, to the intermediate position when at least one intermediate condition is satisfied.

17. The vehicle of claim 16, further comprising:
a blower fan positioned in the interior region and having a variable speed setting;
a chamber operatively connected to the inlet panel;
a fluid level sensor configured to detect fluid level in the chamber relative to the chamber floor;
wherein the at least one intermediate condition includes a first and a second intermediate condition such that the first intermediate condition is satisfied when the fluid level is above a second predefined threshold fluid level and the second intermediate condition is satisfied when the variable speed setting of the blower fan is below a second threshold speed setting; and
wherein the controller is programmed to position the shutter member in the intermediate position when both the first and the second intermediate conditions are satisfied.

18. The vehicle of claim 15, further comprising:
an odor sensor operatively connected to the chamber and configured to detect an odor level of a predefined gas; and
wherein the at least one closing condition is satisfied when the odor level is above a predefined threshold odor level.

19. The vehicle of claim 18, wherein the predefined gas is carbon monoxide.

20. The vehicle of claim 18, wherein the predefined gas is an oxide of sulfur.
